(19) United States
(12) Patent Application Publication
(10) Pub. No.: US 2014/0133027 A1
(43) Pub. Date: May 15, 2014

(54) REFLECTIVE POLARIZING PLATE, DISPLAY DEVICE INCLUDING THE POLARIZING PLATE AND METHOD OF MANUFACTURING THE POLARIZING PLATE

(71) Applicant: SAMSUNG DISPLAY CO., LTD., Yongin-City (KR)

(72) Inventors: Dae-Hwan JANG, Gwangmyeong-si (KR); Gug-Rae JO, Asan-si (KR); Jung-Gun NAM, Seoul (KR); Dae-Young LEE, Suwon-si (KR)

(73) Assignee: SAMSUNG DISPLAY CO., LTD., Yongin-City (KR)

(21) Appl. No.: 13/763,139

(22) Filed: Feb. 8, 2013

(30) Foreign Application Priority Data
Nov. 9, 2012 (KR) 10-2012-0126684

(51) Int. Cl. G02B 5/30

(52) U.S. Cl. CPC G02B 5/3058
USPC 359/485.03; 427/162; 216/24

(57) ABSTRACT

A reflective polarizing plate is monolithically integrated on a surface of a base layer of a display device. The polarizing plate comprises a polarizing area portion and a reflective/blocking area portion, both having a multi-layered structure. The polarizing area portion is patterned to have a plurality of spaced apart reflective wire grid strips. The reflective/blocking area portion is configured to reflect all light incident thereon from a predetermined direction (where that light would not otherwise be used) and to direct the reflected light back to a light providing source where the light can be recycled for other use. Therefore, a brightness and efficiency of the display device is improved.

### PRIORITY STATEMENT

This application claims priority under 35 U.S.C. §119 to Korean Patent Application No. 10-2012-0126684, filed on Nov. 9, 2012 in the Korean Intellectual Property Office (KIPO), the contents of which application are herein incorporated by reference in their entirety.

### BACKGROUND

1. The present disclosure of invention relates to a light polarizing plate, to a display device having the polarizing plate and to a method of manufacturing the polarizing plate. More particularly, the present disclosure of invention relates to a reflective polarizing plate which is capable of improving the brightness and efficiency of a display device using the polarization plate and which is capable of inhibiting bending of a panel of the display device. The present disclosure additionally relates to a display device including the polarizing plate and a method of manufacturing the polarizing plate.

2. Description of Related Technology

Generally, a liquid crystal display (LCD) device includes a polarizing plate used for polarizing all light rays incident there upon from a light source (e.g., a backlighting light source). The polarizing plate may be formed using a PVA (Poly Vinyl Alcohol) film doped with a dichroic iodine. In one class of embodiments, the PVA film is stretched in one particular direction to thereby anisotropically strain the film and cause the PVA molecules to align in accordance with the stretch direction. A polarizing component parallel with the penetration axis is then transmitted through the strained PVA polarizing plate and a polarizing component perpendicular to the penetration axis in the polarizing plate is not. However, the conventional strained PVA polarizing plate does not have a sufficient thermal resistance and may be deteriorated by exposure to an ultra violet (UV) light. Further, the conventional strained PVA polarization plate has a low-efficiency, because almost half of a light which is irradiated from a backlight unit is absorbed by the PVA based polarization plate and converted into wasteful heat.

On the other hand, a reflective wire grid-based polarizing plate may be formed of a grid of metallic wires and is thus a light reflecting type of polarizer, not an absorbing type. P-polarized light transmits through such a wire grid-based polarizing plate while S-polarized light is reflected by the wire grid polarizing plate back to the light source for re-use. The orientation of the passed-through, P-polarized light depends on the extending direction of the wires in the grid. The wire grid polarizing plate including the grid of regularly spaced apart reflective wires has a high-efficiency, because a light which is circularly polarized is reflected back by the reflecting plate to the backlighting unit for further reflection and repeat incidence to again try to transmit through the wire gird polarizing plate in the desired polarization mode. Further, the wire grid polarizing plate has a thermal resistance greater than that of the strained PVA polarizing plate. In one class of embodiments, a wire grid polarizing element which is used in a liquid crystal display device is formed by a nano-imprinting process, thereby allowing a metal wire of the wire grid to be arranged by a predetermined interval shorter than the wavelength of a visible light. (The strip cannot be formed with traditional photolithography techniques that use long wavelength visible light.)

In summary, when using the reflective wire grid polarizing plate, the S-polarized light is recycled to improve the backlighting efficiency. However, it may be possible to improve backlighting efficiency even more.

It is to be understood that this background of the technology section is intended to provide useful background for understanding the here disclosed technology and as such, the technology background section may include ideas, concepts or recognitions that were not part of what was known or appreciated by those skilled in the pertinent art prior to corresponding invention dates of subject matter disclosed herein.

### SUMMARY

The present disclosure of invention recognizes that some of the backlighting provided to a polarizing plate of a display device will not be used by the display device. The polarization plate is therefore patterned to have reflective/blocking area portions where that occurs; for example in non-aperture areas of a Liquid Crystal Display (LCD) device. The reflective/blocking area portions reflect light incident thereon from a predetermined direction back to a light source where the reflected light can be applied for other uses, for example by being recycled and sent back to other areas of the display device. Accordingly, the polarization plate is capable of improving a brightness and/or efficiency attribute of the display device. In one embodiment, the polarization plate is monolithically integrated into one of the panels of the display device to thereby prevent a bending misalignment problem for the panel.

Example embodiments of the present disclosure of invention also provide a method of manufacturing the polarizing plate.

Example embodiments of the present disclosure also provide a display device including the polarizing plate.

According to example embodiments, a polarizing plate includes a polarizing area portion of a multi-layered structure including a plurality of spaced apart wire grid strips, and a reflective/blocking area portion spaced laterally apart from the polarizing area portion, the reflective/blocking area portion being disposed on a first base substrate together with the polarizing area portion.

In example embodiments, the blocking area portion may be disposed on a plane identical to the polarizing area portion.

In example embodiments, a width of the blocking area portion may be greater than a width of each of the wire grid strips.

In example embodiments, an interval between the wire grid strips may be 100 nm or less, and the interval may be identical to the width of the wire grid strip.

In example embodiments, the polarizing area portion and the blocking area portion may include a reflecting layer and an anti-reflecting layer provided on the reflecting layer.

In example embodiments, the reflecting layer may include a metal layer and the anti-reflecting layer may include a metal oxide layer.

In example embodiments, the metal layer may include aluminum, gold, copper, chrome, iron or nickel, and the metal oxide metal layer may include a chrome oxide or an iron oxide.

In example embodiments, the reflecting layer may include a metal layer, and the anti-reflecting layer may include an organic layer which absorbs in the visible range.

In example embodiments, the metal layer may include aluminum, gold, copper, chrome, iron or nickel and the organic layer may include an organic material which absorbs in the visible range.

In example embodiments, the reflecting layer may include a high-reflecting metal layer and the anti-reflecting layer may include a substantially less-reflecting level metal layer.

In example embodiments, the high-reflecting metal layer may include aluminum, gold, copper, chrome, iron or nickel and the less-reflecting metal layer may include tungsten.

According to example embodiments, in a method of manufacturing a polarizing plate, a reflecting layer and an anti-reflecting layer are sequentially provided on a surface of a base layer. The reflecting layer and the anti-reflecting layer are patterned to provide a polarizing area portion and a blocking area portion, the polarizing area portion including a plurality of spaced apart wire grid strips, and the blocking area portion being laterally spaced apart from the polarizing area portion.

In example embodiments, the reflecting layer may include a metal and the anti-reflecting layer may include a metal, an organic or a metal oxide.

In example embodiments, a width of the blocking area portion may be greater than a width of each of the wire grid strips.

In example embodiments, patterning the reflecting layer and the anti-reflecting layer may include providing a nano-imprintable resist layer on the anti-reflecting layer, applying pressure to the nano-imprint resist layer by a nano-imprinting stamp to thereby provide a pattern of spaced apart resist strips, removing the stamp from the resist strips, dry etching the anti-reflecting layer and the resist pattern—providing a photoresist coating layer on the patterned anti-reflecting layer, curing the photoresist coating layer to form a blocking portion area, removing the photoresist coating layer except the blocking area portion, dry etching an area of the reflecting layer except the blocking area portion and removing the photoresist coating layer of the blocking area portion.

According to example embodiments, a display device includes an array substrate including a first polarizing portion, a first base substrate disposed on the first polarizing portion and a thin film transistor disposed on the first base substrate, and an opposite substrate including a second base substrate facing the first base substrate, a second polarizing portion of a multi-layered structure including a plurality of wire grid strips, the wire grid strips being spaced apart from each other, the polarizing portion being disposed under of the second base substrate and a blocking portion spaced apart from the second polarizing portion, the blocking portion disposed under of the second base substrate.

In example embodiments, the blocking area portion may be disposed coplanar with the second polarizing area portion.

In example embodiments, the second polarizing area portion and the blocking area portion may have a dual-layered structure and include a reflecting layer and an anti-reflecting layer provided on the reflecting layer.

In example embodiments, a width of the blocking area portion may be greater than a width of each of the wire grid strips.

In example embodiments, an interval between each the wire grid strips may be 100 nm or less, and the interval may be identical to the widths of the wire grid strips.

According to example embodiments, a polarizing plate includes a reflecting layer and an anti-reflecting layer configured so that the brightness of a display device may be improved by recycling a reflected light reflected by a blocking area portion of the polarization plate, where a blocking function of the blocking area portion prevents reflecting of a light from an inside portion of the display device.

According to example embodiments, the bending of display device is decreased by applying an in-cell polarizing plate at upper and under substrates so that the efficiency of the display device may be increased.

According to example embodiments, processes of forming a blocking area portion and an over-coating layer of the blocking area portion may be omitted. Accordingly, a manufacturing process may be simplified, to thereby increase an efficiency of a polarizing plate and reduce a manufacturing cost.

According to example embodiments, the reflective polarizing plate may be used to replace an anti-reflective ARC film in a display device so that a manufacturing cost of a display device may be decreased.

### BRIEF DESCRIPTION OF THE DRAWINGS

The above and other features and advantages of the present disclosure of invention will become more apparent by describing in detailed example embodiments thereof with reference to the accompanying drawings, in which:

FIG. 1 is a cross-sectional view illustrating a first polarizing plate configured in accordance with an example embodiment of the present disclosure of invention;

FIGS. 2A and 2B are cross-sectional views illustrating respective polarizing plates in accordance with other example embodiments;

FIGS. 3A to 3J are cross-sectional views illustrating a method of making the polarizing plate in FIG. 1;

FIG. 4 is a cross-sectional view illustrating a display device in accordance with an example embodiment of the present disclosure of invention;

FIG. 5A is an enlarged view illustrating a portion of the display device in FIG. 4; and

FIG. 5B is an enlarged view illustrating another portion of the display device in FIG. 4;

### DETAILED DESCRIPTION

Hereinafter, example embodiments in accordance with the present disclosure of invention will be explained in greater detail with reference to the accompanying drawings.

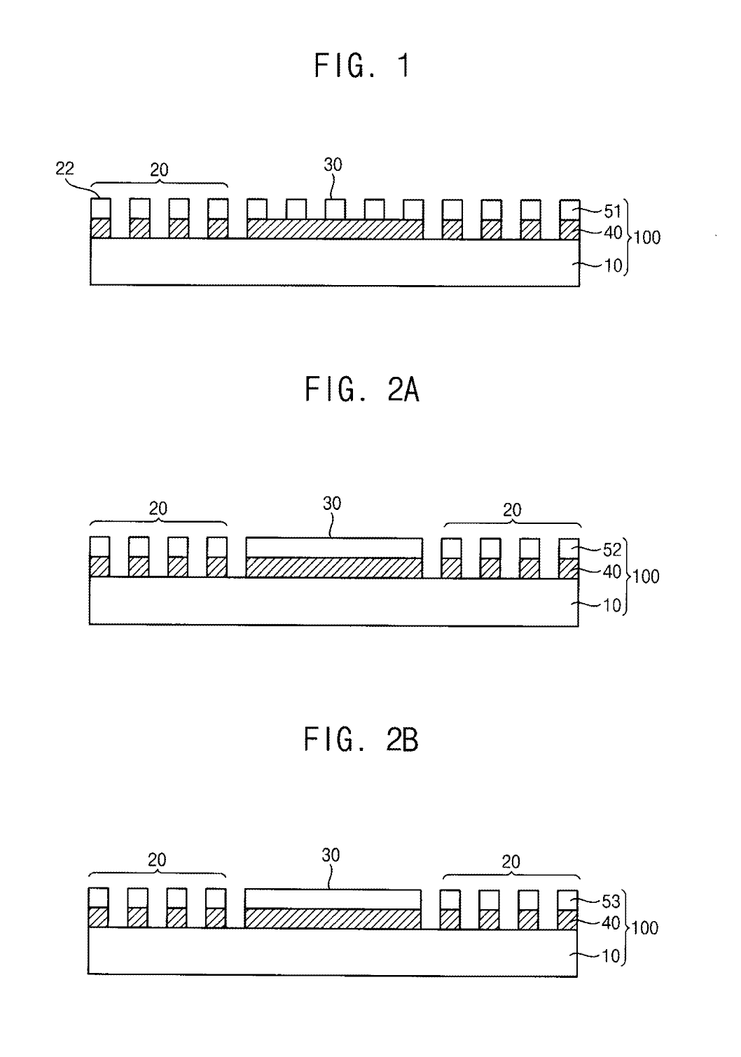

FIG. 1 is a cross-sectional view illustrating a first polarizing plate in accordance with the present disclosure. Briefly, the present disclosure recognizes that non-aperture portions of a backlit display device (as an example, it can also apply to fore-lit displays) do not need to pass through polarized light and may instead reflect back substantially all of backlighting light that is incident upon such non-aperture (not-image defining) portions of the display device.

Referring to the details of exemplary FIG. 1, the illustrated polarizing plate 100 includes a light-passing (e.g., transparent) base layer 10, a polarizing area portion 20 and a light blocking/back-reflecting area portion 30.

The base layer 10 may be a transparent one. More specifically, the base layer 10 may include glass, quartz, a transparent polymer resin or the like.

The polarizing area portion 20 includes a plurality of spaced apart wire grid strips 22 (understood to be extending perpendicularly into the plane of the drawing). The wire grid strips 22 are spaced apart from each other by a predetermined interval. More specifically, the wire grid strips 22 each extends longitudinally in a first direction that is perpendicular to the major plane of the drawing. The strips in the polarizing area portion 20 may have a multi-layered structure, for example, a dual-layered structure where each layer is composed of a respective and function-performing material.

The wire grid strips 22 of the polarizing area potion 20 are spaced apart from each other by a predetermined interval of about 100 nm or less in one embodiment. The width of each wire grid strip 22 may be substantially identical to the interval between adjacent ones of the wire grid strips 22.

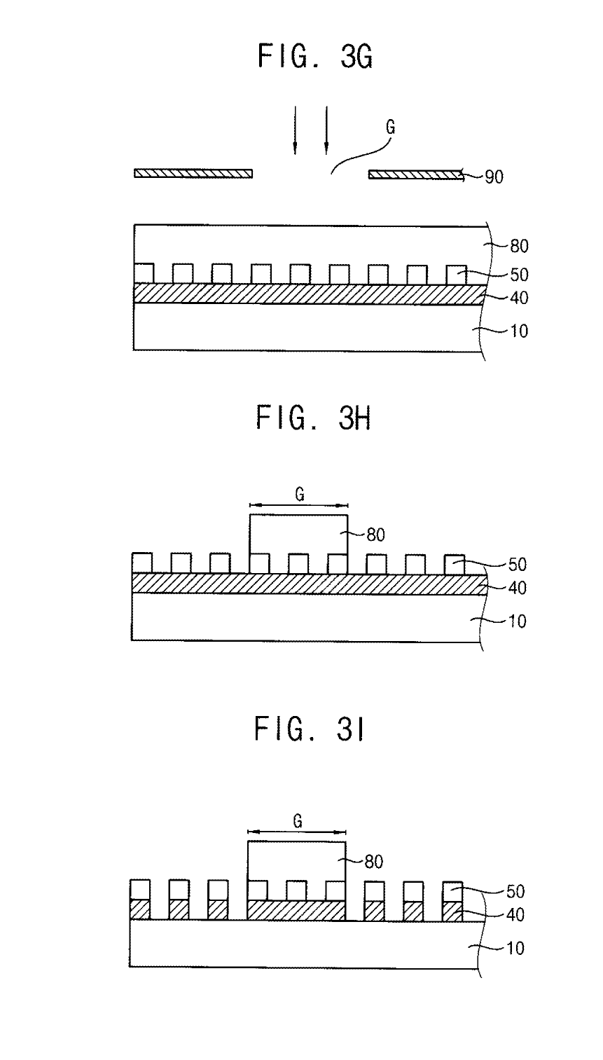

The blocking/reflecting area portion 30 is disposed to be slightly spaced apart from an adjacent one or more of polarizing area portions 20. The width of the blocking/reflecting area portion 30 is greater than the width of an individual wire grid strip 22. For example, the width of the blocking reflecting area portion 22 may be 500 nm or less but more than 100 nm. The respective heights (thicknesses) of the polarizing area portion 20 and the blocking/reflecting area portion 30 may be the same and may range from about 15 nm or more to about 200 nm or less. The blocking/reflecting area portion 30 may include a multi-layered structure, for example, a dual-layered structure. In one embodiment, each polarizing area portion 20 corresponds to a light-passing aperture area of an overlapping pixel part above or below it while each blocking/reflecting area portion 30 corresponds to a light-blocking area of, for example, an overlapping gate line or data line or transistor-containing area in an overlapping TFT array substrate. See for example, FIG. 4 which will be detailed later below.

Hereinafter, the multi-layered structure of the polarizing area portion 20 of FIG. 1 will be described in detail with reference to the accompanying drawings.

Referring to FIG. 1, the polarizing area portion 20 may include a multi-layered structure of at least two layers. More particularly, the polarizing area portion 20 may include a light reflecting layer 40 configured to reflect back light incident from one side of the polarization plate and an anti-reflecting (e.g., light absorbing) layer 51 configured to prevent a reflecting back of light incident from an opposed side of the polarization plate where the anti-reflecting layer 51 is stacked on the reflecting layer 40. The uppermost layer, that is, the anti-reflecting layer 51 of the polarizing area portion 20 may be exposed to the ambient or to another structure (e.g., optical sheet) disposed above it.

Referring still to FIG. 1, the blocking/reflecting area portion 30 may include a multi-layered structure of at least two layers. More particularly, the blocking/reflecting area portion 30 may include a reflecting layer 40 and an anti-reflecting layer 51 that is stacked on the reflecting layer 40. The uppermost layer, that is, the anti-reflecting layer 51 of the blocking/reflecting area portion 30 may be exposed. The uppermost layer of the blocking/reflecting area portion 30 may be patterned similar to the anti-reflecting layer 51 of a corresponding plurality of wire grid strips 22. The wire grid strips are spaced apart from each other by a predetermined interval of about 100 nm or less. The width of the wire grid strip portions may be substantially identical to the interval between adjacent wire grid strips 22.

The reflecting layer 40 may be formed on the base layer 10. The reflecting layer 40 reflects a light which is incident from the rear of the base layer 10. The reflecting layer 40 may be formed of a light reflecting metal layer. The metal layer may include aluminum, gold, copper, chrome, iron, nickel, alloys thereof or the like.

The anti-reflecting layer 51 may be formed on the reflecting layer 40. The anti-reflecting layer 51 is composed of a material that absorbs a light which is incident from the top side of the base layer 10. The anti-reflecting layer 51 may be formed of a metal oxide layer. The metal oxide layer may include chrome oxide, iron oxide or the like. The reflectivity of the metal oxide layer is substantially lower than the reflectivity of the metal layer of the reflecting layer 40.

However, the anti-reflecting layer is not limited to the above-mentioned materials and may include or be substituted for by any other material known to one of the ordinary skill in the art for performing the anti-reflecting function. The polarizing area portion 20 and the blocking/reflecting area portion 30 may include various materials other than the above specified materials. Therefore, the polarizing area portion 20 and the blocking/reflecting area portion 30 may be embodied in many different forms to include various stacked materials.

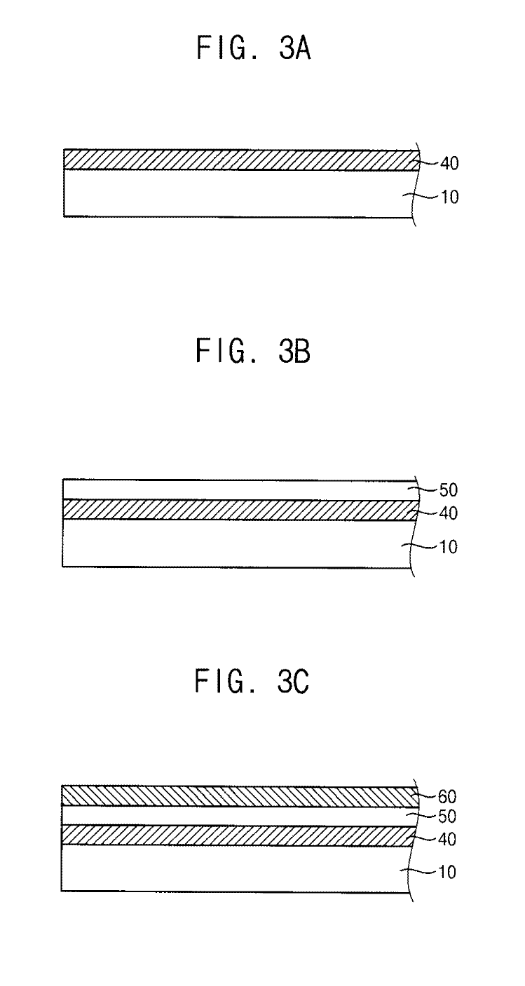

FIGS. 2A and 2B are cross-sectional views illustrating respective polarizing plates in accordance with other example embodiments of the present disclosure.

Referring to FIG. 2A, the polarizing plate 100 of this drawing include a base layer 10, a polarizing area portion 20 and a blocking/reflecting area portion 30. The base layer 10, the polarizing area portion 20 and the blocking portion of the polarizing plate 100 are substantially the same as or similar to those of the above-mentioned embodiment except for a stacked structure thereof. Thus, any repetitive explanation concerning the same or like elements will be omitted. Hereinafter, a stacked structure of the polarizing area portion 20 and the blocking/reflecting area portion 30 will be described in detail with reference to the accompanying drawings.

As illustrated in FIG. 2A, the polarizing area portion 20 and the blocking/reflecting area portion 30 have a stacked structure of at least two layers. For example, the polarizing area portion 20 and the blocking/reflecting area portion 30 include a reflecting layer 40 and an anti-reflecting layer 52 that are stacked on the reflecting layer 40. The uppermost layer, that is, the anti-reflecting layer 52 of the polarizing area portion 20 and the blocking/reflecting area portion 30 may be exposed.

The reflecting layer 40 may be formed on the base layer 10. The reflecting layer 40 reflects a light which is incident from the rear of the base layer 10. The reflecting layer 40 may be formed of a metal layer. The metal layer may include aluminum, gold, copper, chrome, iron, nickel or the like.

The anti-reflecting layer 52 (different from 51 of FIG. 1) may be formed on the reflecting layer 40. The anti-reflecting layer 52 absorbs a light which is incident from the front of the base layer 10. The anti-reflecting layer 52 may be formed of an organic material layer. The organic layer may include a visible-light absorbing organic material or the like. The reflectivity of the organic layer is substantially lower than the reflectivity of the metal layer of the reflecting layer. Alternatively or additionally, in the blocking/reflecting area portion 30 of the embodiment of FIG. 2A, the anti-reflecting layer 52 is blanket formed rather than being formed of strips as it is in the polarizing area portion 20.

Referring to FIG. 2B, the polarizing plate 100 includes a base layer 10, a polarizing area portion 20 and a blocking/reflecting area portion 30. The base layer 10, the polarizing area portion 20 and the blocking/reflecting area portion 30 of the polarizing plate 100 are substantially the same as or similar to the above-mentioned embodiment, thus, any repetitive explanation concerning the same or like elements will be omitted. Hereinafter, a stacked structure of the polarizing area portion 20 and the blocking/reflecting area portion 30 will be described in detail with reference to the accompanying drawings.

As illustrated in FIG. 2B, the polarizing area portion 20 and the blocking/reflecting area portion 30 have a stacked structure of at least two layers. For example, the polarizing area portion 20 and the blocking/reflecting area portion 30 may include a reflecting layer 40 and an anti-reflecting layer 53 that are stacked on the reflecting layer 40. The uppermost layer, that is anti-reflecting layer 53 of the polarizing area portion 20 and the blocking/reflecting area portion 30 may be exposed.

The reflecting layer 40 may be formed on the base layer 10. The reflecting layer 40 reflects a light which is incident from the rear of the base layer 10. The reflecting layer 40 may be formed of a metal layer. The metal layer may include aluminum, gold, copper, chrome, iron, nickel or the like.

The anti-reflecting layer 53 (different from 52 of FIG. 2A) may be formed on the reflecting layer 40. The anti-reflecting layer 53 absorbs a light which is incident from the front of the base layer 10. The anti-reflecting layer 53 may be formed of a low-reflecting metal layer. The low-reflecting metal layer may include tungsten or the like. The reflectivity of the low-reflecting metal layer is lower than the reflectivity of the metal layer of the reflecting layer. Alternatively or additionally, in the blocking/reflecting area portion 30 of the embodiment of FIG. 2B, the anti-reflecting layer 53 is blanket formed rather than being formed of strips as it is in the polarizing area portion 20.

Hereinafter, a method of manufacturing a polarizing plate in accordance with the present disclosure will be described in detail with reference to the accompanying drawings.

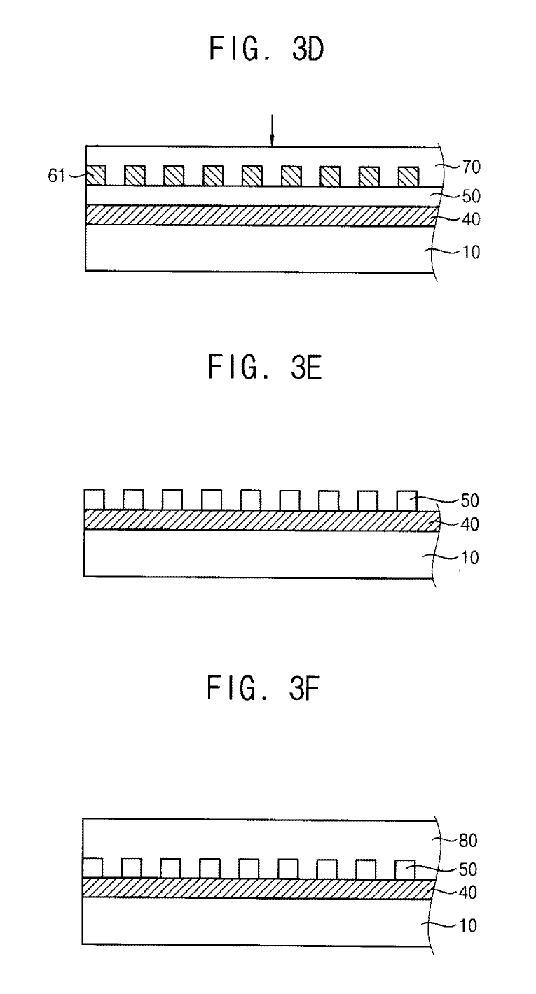

FIGS. 3A to 3J are cross-sectional views illustrating the formation of the polarizing plate of FIG. 1.

Referring to FIGS. 3A and 3B, a reflecting layer 40 and an anti-reflecting layer 50 are sequentially blanket formed (e.g., depositing by sputtering) on a base layer 10.

As illustrated in FIG. 3A, the reflecting layer 40 is formed on the base layer 10. The reflecting layer 40 may be formed of a metal layer.

As illustrated in FIG. 3B, the anti-reflecting layer 50 is formed on the reflecting layer 40. The anti-reflecting layer 50 may be formed of a metal oxide layer for the case of FIG. 1, or of a spin-coated organic layer (51) for the case of FIG. 2A or of a low-reflecting level metal layer (52) for the case of FIG. 2B.

Referring to FIG. 3C, a nano-imprintable resist layer 60 is blanket formed on the anti-reflecting layer 50. The nano-imprintable resist layer 60 may include a plastically-deformable polymer.

Referring to FIG. 3D, the nano-imprintable resist layer 60 is non-elastically deformed, for example by being pressurized by a stamp 70 to form an array of resist strips 61 spaced apart in accordance with a predetermined interval corresponding to that of the to be formed reflective metal strips of FIG. 1.

The stamp 70 has a protruding shape for forming the resist strips 61. For example, the stamp 70 has a recessed shape corresponding to that of the resist strips 61.

When the size of the stamp 70 is determined corresponding to the size of the base layer 10, a pressure is applied at once to the base layer 10 by the stamp 70 to form the resist strips 61. Then, as a result, the resist strips are formed as uniformly spaced apart features on the entire surface the base layer 10.

When the size (area) of the stamp 70 is smaller than the total size (area) of the base layer 10, the base layer is pressurized several times to by stamp to form the resist strips 61 on substantially the entire surface of the base layer 10.

Referring to FIG. 3E, the stamp 70 is removed from the resist strips 61, and then, a dry etching process (e.g., reactive ion etch) is performed on the base layer 10 to thereby non-photolithographically pattern the anti-reflecting layer 50 until an upper surface of the reflecting layer 40 is exposed (this being an endpoint signal for the dry etch process). After the dry etching process, the resist strips 61 remaining on the structure are additionally and selectively removed by for example dry-etching from the pattered anti-reflecting layer 50.

Referring to FIG. 3F, a photoresist coating layer 80 is formed on the patterned anti-reflecting layer 50. The photoresist coating layer 80 may include a UV-curable polymer.

Referring to FIG. 3G, a photo mask 90 having an opening corresponding to a blocking portion area G is disposed on (or otherwise optically coupled to) the photoresist coating layer 80. A portion of the photoresist coating layer 80 exposed by the opening of the photo mask 90 corresponding to the blocking portion area G is cured by an ultraviolet (UV) light. The blocking portion area G has a width corresponding to the width of the blocking/reflecting area portion 30 of the above described embodiments. More particularly, the width of the blocking portion area G is greater than the interval of the resist strips 61.

Referring to FIG. 3H, a portion of the photoresist coating layer 80 except the cured blocking portion area G is selectively removed.

Referring to FIG. 3I, the exposed portions of the reflecting layer 40 (meaning not the portion under the remaining blocking portion area G of the photoresist coating layer 80) are dry-etched. The patterned anti-reflecting layer 50 and the patterned photoresist coating layer 80 corresponding the blocking portion area G serve as a hard mask, so that the exposed portions of the reflecting layer 40, for example those around but not inside the blocking portion area G are etched. Accordingly, the patterned anti-reflecting layer 50 and the patterned reflecting layer 40 remain on the base layer 10. The dry-etching process is performed until an upper surface of the base layer 10 is exposed as an endpoint for the etch process.

Referring to FIG. 3J, the blocking portion area G of the photoresist coating layer 80 is selectively removed from the base layer 10. A solvent selective for the cured polymer may be used.

Hereinafter, a display device including a reflective polarizing plate in accordance with the present disclosure will be described in detail with reference to the accompanying drawings.

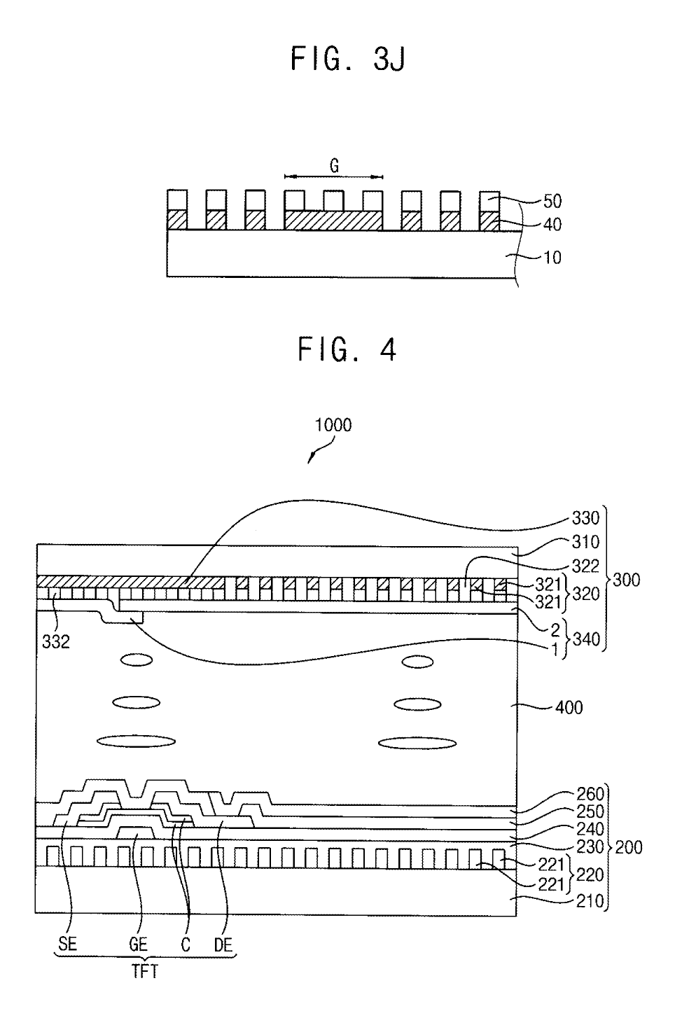

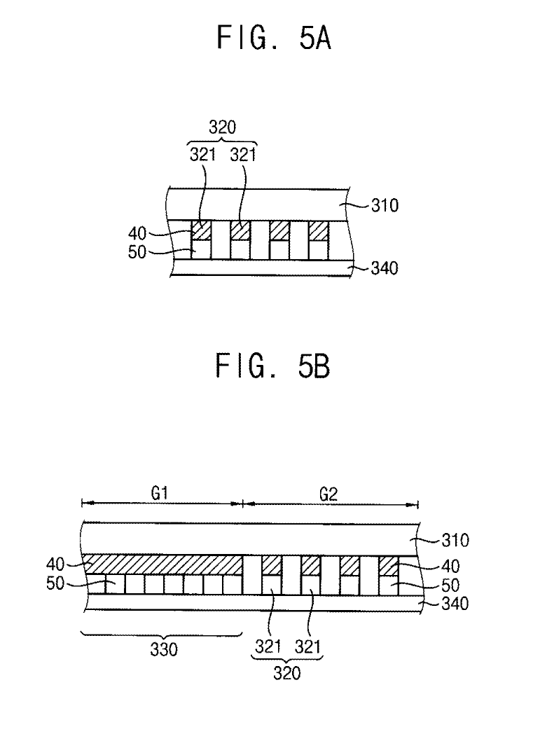

FIG. 4 is a cross-sectional view illustrating an exemplary display device 1000 in accordance with the present disclosure of invention. FIG. 5A is an enlarged view illustrating a portion of the display device in FIG. 4. FIG. 5B is an enlarged view illustrating another portion of the display device in FIG. 4.

Referring to FIG. 4, the display device 1000 includes a backlighting unit (not illustrated but understood to be optically coupled to deliver backlighting illumination to the exterior side of a second base substrate 310 in this illustrated embodiment). The display device 1000 further includes an array substrate 200, a liquid crystal layer 400 and an opposite substrate 300. In this embodiment, respective polarization plates 220 and 320 are monolithically integrated as parts of the array substrate 200 and the opposite substrate 300 respectively.

The backlight unit (not illustrated) includes a reflecting plate (not illustrated). A light which is incident from the backlight unit (not illustrated) to portions of the display device 1000 that do not need such light for forming a desired image with appropriately polarized light may be reflected back by one or both of the polarization plates (220, 320) of the display device to the backlight unit (not illustrated) for re-use. More specifically, the reflecting plate (not illustrated) of the backlight unit may reflects the returned light again for a second or Nth time re-application (N>2) to the panel assembly 200/400/300. In the illustrated example the backlighting light is understood to shine for a first time and for second through Nth reflected times on an exterior side of the upper substrate 310 and on the corresponding and reflective side of the corresponding polarization plate 320.

The TFT array substrate 200 is aligned to receive polarized light from the backlight unit (not illustrated). The backlight unit (not illustrated) may be disposed at a different position other than immediately adjacent to the rear of the array substrate 200 and may be, for example, optically coupled to the display device 1000 for example by means of a light guide plate (LGP, not shown) that is operatively coupled to the second base substrate 310. The array substrate 200 includes a first base substrate 210, a first polarizing portion 220, a planarization layer 230 disposed on the first polarizing portion 220 and a display element disposed on the planarization layer 230.

The display element includes a switching element, for example, a thin film transistor (TFT). More particularly, the switching element (TFT) includes a gate electrode GE, a gate insulation layer 240, a semiconductive layer C, a source electrode SE and a drain electrode DE. A plurality of gate lines is formed on the planarization layer 230. The gate electrode GE extends as one of many similar branches from the gate line. The gate insulation layer 240 covers the gate lines and the gate electrode GE. The semiconductive layer C is formed on the gate insulation layer 240 corresponding to the gate electrode GE. (The semiconductive layer C may be formed of semiconductive oxides instead of from traditional silicon in some cases.) Source lines are formed on the gate insulation layer 240 to cross the gate lines. The source electrode SE extends as one of many similar branches from the source line. The source electrode SE and the drain electrode DE are spaced apart from each other on the semiconductive layer C.

The array substrate 200 further includes a passivation layer 250. The passivation layer 250 covers and protects the switching element TFT. A transparent pixel electrode 260 (e.g., one formed of ITO or IZO) is formed to correspond to each of pixel areas and the pixel electrode 260 is electrically connected to the drain electrode DE of the switching electrode TFT.

In another example embodiment, the switching element TFT may be a thin film transistor of a gate-on-top type.

The first polarizing portion 220 is disposed on the first base substrate 210 and the first polarizing portion 220 includes a plurality of wire grid strips 221 which are spaced apart from each other by a predetermined interval. As illustrated in FIG. 4, in this example embodiment, the first polarizing portion 220 includes a plurality of wire grid strips 221, however, the polarizing portion 220 may have a different shape.

The liquid crystal layer 400 is disposed on the array substrate 200. The display device further includes an alignment film (not illustrated). The alignment film (not illustrated) contacts with the liquid crystal layer 400 and is used for pre-aligning the liquid crystal molecules in the absence of a controlling electric field. The alignment films may be disposed on the array substrate 200 and the opposite substrate 300, respectively.

The opposite substrate 300 is disposed on the liquid crystal layer 400. The opposite substrate 300 includes a second base substrate 310 facing the first base substrate 210, a second polarizing area portion 320 disposed under the second base substrate 310, a blocking/reflecting area portion 330 of a multi-layered structure which is spaced apart from the polarizing area portion 320 under the second base substrate 310 and a color filter layer 340 disposed under the second polarizing area portion 320 and the blocking/reflecting area portion 330.

The second polarizing area portion 320 is disposed under the second base substrate 310. The second polarizing area portion 320 includes a plurality of wire grid strips 321 of a multi-layered structure, which extend in a first direction. The multi-layered structure includes a plurality of the wire grid strips 321 which are spaced apart from one another. The wire grid strips 321 are substantially the same as or similar to the wire grid strips 22 illustrated in FIG. 1. The second polarizing area portion 320 has a multi-layered structure and the multi-layered structure may be a dual-layered structure.

The wire grid strips 321 of the second polarizing area portion 320 are spaced apart from each other by a predetermined interval of about 100 nm or less. The height of the wire grid strip ranges from about 150 nm or more to about 200 nm or less. The width of each of the wire grid strips 321 may be substantially identical to the interval between the wire grid strips 321.

The blocking/reflecting area portion 330 is spaced apart from the second polarizing area portion 320. The blocking/reflecting area portion 330 has a multi-layered structure and the multi-layered structure may be a dual-layered structure. The width of the blocking/reflecting area portion 330 is greater than the width of the wire grid strip 321 and the width is about 500 nm or less.

Referring to FIG. 5A, the second polarizing area portion 320 and the blocking/reflecting area portion 330 have a stacked structure of at least two layers. The second polarizing area portion 320 and the blocking/reflecting area portion 330 include a reflecting layer 40 and an anti-reflecting layer 50. The uppermost layer of the second polarizing area portion 320 and the blocking/reflecting area portion 330 may be the anti-reflecting layer 50 exposed to the ambient or to another structure (e.g., optical sheet) disposed above it.

Referring to FIG. 5A, the reflecting layer 40 of the second polarizing area portion 320 and the blocking/reflecting area portion 330 may be formed under the base substrate 310. The reflecting layer 40 reflects a light which is incident from the backlight unit (not illustrated) to improve the brightness and re-use un-needed light energy, thus improving efficiency. The reflecting layer 40 may be formed of a high-reflecting metal layer. The high-reflecting metal layer may include aluminum, gold, copper, chrome, iron, nickel or the like.

The high-reflecting layer 50 may serve as an upper electrode at the display device.

Referring to FIG. 5B, the anti-reflecting layer 50 may be formed under the reflecting layer 40. The anti-reflecting layer 350 absorbs a light which is incident from inside of the display device to improve contrast and, also, the anti-reflecting layer 50 may serves as an anti-reflecting film. The anti-reflecting layer 50 may be composed of a low-reflecting metal oxide layer and/or a low-reflecting organic layer. The low-reflecting organic layer may include an organic material which absorbs well in the visible range. The reflecting layer 40 may be formed of a high-reflecting metal layer. The high-reflecting metal layer may include aluminum, gold, copper, chrome, iron, nickel or the like.

A gap 322 between the wire grid strips 321 of the second polarizing area portion 320 and a gap 332 in the blocking/reflecting area portion 330 may be filled with a transparent material or may be an empty space.

The color filter layer 340 is disposed under the second polarizing area portion 320 and under the blocking/reflecting area portion 330. The color filter layer 340 may be disposed on the array substrate 200. Referring to FIG. 4, the color filter layer 340 includes a first color filter and a second color filter 1 and 2. In one embodiment, each of the color filters 1 and 2 includes a red, green and blue pigment.

The polarizing portions of the array substrate 200 and the opposite substrate 300 includes the reflecting layer and anti-reflecting layer so that a light which is reflected at the blocking portion is recycled and a light which is incident from the inside of the display device is prevented from being uncontrollably reflected, to thereby improve the contrast, brightness and efficiency of the display device.

Misalignment of parts of the display device 1000 is reduced by using an in-cell integrally disposed polarizing plate at upper and under substrates, to thereby improve the efficiency of the display device.

A blocking portion processing and an over coating layer processing may be omitted so that a manufacturing process may be simplified and the manufacturing coast is decreased, also, the efficiency of a polarizing plate may be improved.

The polarizing portion may replace a common anti-reflecting film (conventional ARC) so that the manufacturing coast may be decreased.

Hereinafter, the improvement of the brightness of the display device will be described in detail with reference to the accompanying drawings.

The reflecting layer 40 may be formed under the base substrate. The reflecting layer 40 reflects efficiently a light which is incident from the backlight unit (not illustrated) to improve the brightness. The reflecting layer 40 may be formed of a high-reflecting metal layer.

Referring to FIG. 5A, some of light which is incident from the backlight unit (not illustrated) to the display device and has the desired polarization transmits through the second polarizing area portion 320. Other parts of the light (those that do not have the desired polarization) are reflected by the second polarizing portion and directed again to the backlight unit (not illustrated). The light which was reflected by the polarizing area portion 320 and directed back to the backlight unit (not illustrated) is converted from being circularly polarized light to linearly polarized light by the reflecting plate (not illustrated) of the backlight unit (not illustrated) and then is made incident again to the display device.

When the light which is incident from the back light unit (not illustrated) transmits through the display device, the transmittance of the light which transmits through the display device, the incident light of S-polarized light being completely depleted, is referred to as total transmittance Tₜₒₜₐₗ. The reflectivity of the S-polarized light is referred to as ‘R’, the reflectivity of the P-polarized light is referred to as ‘T’ and the recycling-efficiency of the backlight unit (not illustrated) is referred to as ‘a’. When the S-polarized light is reflected, the S-polarized light is recycled by the backlight unit and the S-polarized light transmits through the second polarizing area portion 320 and the S-polarized light is converted to a P-polarized light. Therefore, the total transmittance Tₜₒₜₐₗ is sum of the first transmittance of the P-polarized light T, the second transmittance of the P-polarized light aRT and the nth transmittance of the P-polarized light a″R″T. (n is natural number)

Therefore, Tₜₒₜₐₗ=T+aRT+a²R²T+ . . . +aⁿRⁿT=T/(1−aR) by an infinite series analysis.

When comparing the transmittance of a conventional polarizing plate with the transmittance of the opposite substrate 300 of this embodiment, the efficiency of the brightness is E_{wgp}=Tₜₒₜₐₗ/T=1/(1−aR).

Therefore, the display device of this embodiment includes a polarizing portion with a plurality of wire grid strips, to thereby improve the brightness thereof

Referring to FIG. 5B, the display device uses the opening rate of an opening portion G2 (a.k.a. aperture portion G2) of the opposite substrate 300 and the total reflection of a blocking portion G1 of the reflecting layer 40. A light which is incident from the backlight unit (not illustrated) to the opening portion G2 of the display device transmits through the second polarizing area portion 320 and some of the light is reflected and directed to the backlight unit (not illustrated) again. A light which is incident from the backlight unit (not illustrated) to the blocking portion G1 of the display device is reflected back by the reflecting layer 40 of the blocking portion and then is directed to the backlight unit (not illustrated). The part of the light which was directed back to the backlight unit (not illustrated) has its polarization (circularly polarized) converted by the reflecting plate (not illustrated) of the backlight unit (not illustrated) and then is incident again to the display device. Therefore, the brightness of the display device is a sum of the reflectivity of the blocking portion G1, the recycling-efficiency of a light of the backlight unit and the transmittance of the opposite substrate 300 which is illustrated in FIG. 5A.

Hereinafter, the reflectivity of the blocking portion G1, the recycling-efficiency of a light of the backlight unit and the transmittance of the opposite substrate 300 is described in detail with formulas.

The opening ratio (aperture ratio) of the opening portion G2 is referred to as ‘A’, the transmittance of a P-polarized light is referred to as ‘T’, the transmittance of the blocking portion G1 is referred to as “R” and the recycling-efficiency of the backlight unit (not illustrated) is referred to as ‘a’. When a light which is incident from the backlight unit (not illustrated) transmits through the first display device at first, the first transmittance is referred to as ‘AT’. The reflecting of the S-polarized light reflected by the second polarizing of the opening portion G2 is referred to as ‘AR’ and the first reflecting value of the light which is reflected by the reflecting layer 40 of the blocking portion 330 of the blocking portion G1 is referred to as ‘(1−A)R″, so that the reflecting value which is recycled by the backlight unit (not illustrated) is referred to as ‘aAR+a(1−A)R″. Therefore, the second transmittance of the probability of a light, which can not transmit through the second polarizing portion 320 at first, is referred to as ‘aA²RT+aA(1−A)R′T’. Tₜₒₜₐₗ is sum of the first transmittance, second transmittance and nth transmittance.

Therefore, Tₜₒₜₐₗ=AT/1−[aAR+a(1−A)R′] by an infinite series analysis.

When comparing between the transmittance of a common polarizing plate and the transmittance of the opposite substrate 300, the efficiency of the brightness is E_{wgp}=Tₜₒₜₐₗ/AT=1−[aAR+a(1−A)R′]. (n is natural number)

Therefore, the brightness of the display device of example embodiments of the present disclosure of invention which includes a polarizing portion having a plurality of wire grid strips is improved over that of a conventional display device.

Although example embodiments of the present disclosure of invention have been described for a liquid crystal display (LCD) device as an example, the polarizing plate including the reflecting layer may be used in other forms of display devices where polarization is desired as will be appreciated by those skilled in the art in light of the foregoing. Among the many modifications that are possible is the use of the disclosed polarization plate in an Organic light emitting display device as an anti-reflecting film.

Example embodiments of the present disclosure also may be used in other display devices using a polarized light, for example if polarization is used to create a perception of 3D images.

The foregoing is illustrative of the present disclosure of invention and is not to be construed as limiting thereof. Although example embodiments have been described, those skilled in the art will readily appreciate in light of the foregoing that many modifications are possible in the example embodiments without materially departing from the novel teachings and advantages of the present disclosure. Accordingly, all such modifications are intended to be included within the scope of the present teachings.

What is claimed is:

1. A reflective polarizing plate comprising:
a first base substrate having opposed first and second sides facing respective first and second opposed directions;
a polarizing area portion disposed on the first base substrate and having a multi-layered structure including a plurality of linear wire grid strips, the wire grid strips being spaced apart from each other such that linearly polarized light can pass through the spacings; and
a reflective/blocking area portion also disposed on the first base substrate and laterally spaced apart from the polarizing area portion, the reflective/blocking area portion being configured to reflect back to a light sourcing mechanism, light that is incident upon the reflective/blocking area portion from the first direction and to block reflection of light that is incident upon the reflective/blocking area portion from the opposed second direction.

2. The polarizing plate of claim 1, wherein the blocking area portion is disposed coplanar with the polarizing area portion.

3. The polarizing plate of claim 2, wherein a width of the blocking area portion is greater than a width of each of the wire grid strips.

4. The polarizing plate of claim 3, wherein a spacing interval between the wire grid strips is 100 nm or less, and the interval is substantially the same as the width of the wire grid strips.

5. The polarizing plate of claim 3, wherein the polarizing area portion and the reflective/blocking area portion each comprises a reflecting layer and an anti-reflecting layer stacked one on the other.

6. The polarizing plate of claim 3, wherein the reflecting layer comprises a metal layer, and the anti-reflecting layer comprises a metal oxide layer.

7. The polarizing plate of claim 6, wherein
the metal layer comprises at least one member selected from the group consisting of aluminum, gold, copper, chrome, iron and nickel, and
the metal oxide metal layer comprises at least of one member selected from the group consisting of a chrome oxide and an iron oxide.

8. The polarizing plate of claim 3, wherein the reflecting layer comprises a metal layer, and the anti-reflecting layer comprises an organic layer.

9. The polarizing plate of claim 8, wherein
the metal layer comprises at least one member selected from the group consisting of aluminum, gold, copper, chrome, iron and nickel, and
the organic layer comprises an organic material which absorbs in the visible light range.

10. The polarizing plate of claim 3, wherein the reflecting layer comprises a relatively high-reflecting metal layer, and anti-reflecting layer comprises a substantially less-reflecting metal layer.

11. The polarizing plate of claim 10, wherein the high-reflecting metal layer includes at least one member selected from the group consisting of aluminum, gold, copper, chrome, iron and nickel, and wherein the less-reflecting metal layer comprises tungsten.

12. A method of manufacturing a polarizing plate, the method comprising:
providing a reflecting layer and an anti-reflecting layer sequentially on a base substrate layer, the base substrate layer having opposed first and second sides facing respective first and second opposed directions; and
patterning the reflecting layer and the anti-reflecting layer to thereby provide a polarizing area portion and a reflective/blocking area portion, the polarizing area portion including a plurality of wire grid strips, the wire grid strips being spaced apart from each other by a predetermined interval, the reflective/blocking area portion being laterally spaced apart from the polarizing area portion and the reflective/blocking area portion providing a light reflecting function for light incident thereupon from one of the first and second directions.

13. The method of claim 12, wherein the reflecting layer comprises a metal, and wherein the anti-reflecting layer comprises at least one member selected from the group consisting of a metal, an organic material and a metal oxide.

14. The method of claim 12, wherein a width of the reflective/blocking area portion is greater than a width of each of the wire grid strips.

15. The method of claim 12, wherein patterning of the reflecting layer and of the anti-reflecting layer comprises:
providing a nano-imprintable resist layer on the anti-reflecting layer;
applying a nano-imprinting stamp to the nano-imprintable resist layer to thereby nonelastically define a pattern of spaced apart resist strips;
removing the stamp from the resist strips;
dry etching the anti-reflecting layer and the resist strips to thereby define patterned anti-reflecting layer;
providing a photoresist coating layer on the patterned anti-reflecting layer;
curing the photoresist coating layer to form a blocking portion pattern area;
removing the photoresist coating layer except for at the blocking portion pattern area;
dry etching exposed portions the reflecting layer, this excluding the blocking portion pattern area; and
removing the photoresist coating layer of the blocking portion pattern area.

16. A display device comprising:
an array substrate comprising a first polarizing portion, a first base substrate disposed on the first polarizing portion and a thin film transistor disposed on the first base substrate; and
an opposite substrate comprising a second base substrate facing the first base substrate, a second polarizing portion of a multi-layered structure including a plurality of wire grid strips, the wire grid strips being spaced apart from each other, the second polarizing portion being disposed under of the second base substrate and having a reflective/blocking area portion spaced apart from the wire grid strips, the reflective/blocking area portion disposed under of the second base substrate.

17. The display device of claim 16, wherein the reflective/blocking area portion is disposed coplanar with the a polarizing area portion defined by the wire grid strips, of the second polarizing portion.

18. The display device of claim 16, wherein the second polarizing area portion and the reflective/blocking area portion have a dual-layered structure and comprise a reflecting layer and an anti-reflecting layer provided on the reflecting layer.

19. The display device of claim 16, wherein a width of the reflective/blocking area portion is greater than a width of each of the wire grid strips.

20. The display device of claim 19, wherein an interval between the wire grid strips is 100 nm or less, and the interval is substantially the same as one of the widths of the wire grid strips.
